(19) United States
(12) Patent Application Publication
(10) Pub. No.: US 2008/0188592 A1
(43) Pub. Date: Aug. 7, 2008

(54) Select Elastomeric Blends and Their Use in Articles

(76) Inventors: Walter Harvey Waddell, Pasadena, TX (US); Donald Sheley Tracey, Kingwood, TX (US); Glenn Edward Jones, Topeka, KS (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/791,784

(22) PCT Filed: Sep. 30, 2005
(86) PCT No.: PCT/US05/35041

§ 371 Date: May 29, 2007

Related U.S. Application Data
(60) Provisional application No. 60/639,939, filed on Dec. 29, 2004.
(60) Provisional application No. 60/716,307, filed on Sep. 12, 2005.

(51) Int. Cl. C08K 3/34; C08K 5/00; C08L 9/00; C08J 5/14; C08L 9/06; C08K 3/26

(52) U.S. Cl. 524/13; 525/55; 525/232; 525/98; 525/88; 524/426; 524/445; 524/52; 523/152

(57) ABSTRACT

The invention includes select blends of elastomeric compositions of at least one halogenated elastomer and at least one other elastomer to impart certain properties to articles made from those select blends. For example, the at least one halogenated elastomer may be at least one halogenated butyl rubber, at least one halogenated star-branched butyl rubber, or at least one halogenated random copolymer of a C₄ to C₇ isomonoolefin derived unit, such as an isobutylene derived unit, and at least one other polymerizable unit, such as methylstyrene. The invention also includes methods to improve the brittleness point of articles made from those select blends.

### CROSS REFERENCE TO RELATED APPLICATION

This application claims the benefit of Provisional Application Nos. 60/639,939 filed Dec. 29, 2004, and 60/716,307, filed Sep. 12, 2005, the disclosures of which are incorporated by reference.

### FIELD OF THE INVENTION

The present invention includes select blends of elastomeric compositions of at least one halogenated elastomer and at least one other elastomer to impart certain properties to articles made from those select blends. The invention also includes methods to improve the brittleness point of articles made from those select blends.

### BACKGROUND

Manufacturers of tires and tire components have endless choices when fabricating such items. For example, the selection of ingredients for the commercial formulations of tires and tire components depends upon the balance of properties desired and its intended end use (e.g., aircraft, truck/bus or automobile). In particular, when fabricating that portion of the tire relied upon for air impermeability such as the tire innerliner, manufacturers have applied a myriad of approaches including the widespread use of “butyl” rubbers or elastomers in various embodiments. Butyl rubbers, generally, copolymers of isobutylene and isoprene, optionally halogenated, have widespread application due to their ability to impart desirable air impermeability properties for the tire. Halobutyl rubbers (halogenated butyl rubber) are the polymers of choice for air-retention in tire innerliners for passenger, truck/bus, and aircraft applications. See, e.g., U.S. Pat. No. 5,922,153, U.S. Pat. No. 5,491,196, EP 0 102 844 and EP 0 127 998. Butyl rubbers and halobutyl rubbers are commercially available, for example, from Lanxess Corporation, Pittsburgh, Pa., and ExxonMobil Chemical Company, Houston, Tex. Bromobutyl rubber, chlorobutyl rubbers, and branched (“star-branched”) halogenated butyl rubbers are isobutylene-based elastomers that can be formulated for these specific applications. EXXPRO™ elastomers (ExxonMobil Chemical Company, Houston, Tex.), generally, halogenated random copolymers of isobutylene and para-methylstyrene, have also been of particular interest due to their improvements over butyl rubbers. Therefore, in many cases, a blend of EXXPRO™ elastomers with secondary elastomers or other polymers affords a compound having a desirable balance of properties achieved through suitable processing windows. See, e.g., U.S. Pat. No. 6,293,327 and U.S. Pat. No. 5,386,864, U.S. Patent Application Publication No. 2002/151636, JP 2003170438, and JP 2003192854 (applying various approaches of blends of commercial EXXPRO™ elastomers with other polymers).

Other background references include U.S. Pat. Nos. 5,063,268, 5,391,625, 6,051,653, and 6,624,220, WO 1992/02582, WO 1992/03302, WO 2004/058825, EP 1 331 107 A, and EP 0 922 732 A.

Although past endeavors have improved the desired balance of properties of a tire and its ultimate performance, the tire industry continually seeks improvements to past applications. Of the many properties, processing properties of the “green” (precured) composition in the tire plant versus in-service performance of the cured tire composite are important. A continuing in-service problem in the tire industry is the ability to improve the endurance of tires for applications in extreme weather conditions such as is required for agricultural tires, aircraft tires, earthmover tires, heavy-duty truck tires, mining tires, and even passenger car tires. For example, the performance of the tire innerliner under low temperature conditions is important since any cracking can compromise the desirably low air permeability required. Thus, the problem of improving the low temperature flex fatigue properties of elastomeric compositions without affecting the processability of the uncured elastomeric compositions or the physical property performance of the cured elastomeric compositions useful for tire articles while maintaining or improving the air impermeability still remains.

### SUMMARY OF THE INVENTION

The invention provides for select blends of elastomeric compositions of at least one halogenated elastomer and at least one other elastomer to impart certain properties for the subsequent cured elastomeric composition. For example, the at least one halogenated elastomer may be at least one halogenated butyl rubber, at least one halogenated star-branched butyl rubber, or at least one halogenated random copolymer of a C₄ to C₇ isomonoolefin derived unit, such as an isobutylene derived unit, and at least one other polymerizable unit, such as methylstyrene, preferably para-methylstyrene.

In an embodiment, the invention provides for an article made from at least one cured elastomeric composition comprising from about 70 phr to about 97 phr of at least one halogenated isobutylene based elastomer and from about 30 phr to about 3 phr of at least one secondary elastomer; wherein the secondary elastomer has a Tg of about −65° C. or less and wherein the article has a brittleness point of about −48° C. or less.

The invention also provides for methods to improve the brittleness point of an article.

In an embodiment, the invention provides for a process to improve the brittleness point of an article, the process comprising producing the article from at least one cured elastomeric composition; wherein the at least one cured elastomeric composition comprises an effective amount of at least one halogenated isobutylene based elastomer and at least one secondary elastomer having a Tg of about −65° C. to impart a brittleness point of about −48° C. or less to the article.

### BRIEF DESCRIPTION OF THE DRAWINGS

FIGS. 1, 2, and 3 show the brittleness temperatures (° C.) of Comparative Examples and Inventive Examples. For example, in an embodiment, the brittleness point of certain Inventive examples being −48° C. or less.

### DETAILED DESCRIPTION OF THE INVENTION

Various specific embodiments, versions and examples of the invention will now be described, including preferred embodiments and definitions that are adopted herein for purposes of understanding the claimed invention. For determining infringement, the scope of the “invention” will refer to any one or more of the appended claims, including their equivalents, and elements or limitations that are equivalent to those that are recited.

As used herein, the new numbering scheme for the Periodic Table Groups is used as set forth in CHEMICAL AND ENGINEERING NEWS, 63(5), 27 (1985).

As used herein, a polymer may be used to refer to homopolymers, copolymers, interpolymers, terpolymers, etc. Likewise, a copolymer may refer to a polymer comprising at least two monomers, optionally with other monomers.

As used herein, when a polymer is referred to as comprising a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, isoolefin refers to any olefin monomer having at least one carbon having two substitutions on that carbon.

As used herein, multiolefin refers to any monomer having two or more double bonds, for example, a multiolefin may be any monomer comprising two conjugated double bonds such as a conjugated diene such as isoprene.

As used herein, isobutylene based elastomer or polymer refers to elastomers or polymers comprising at least 70 mol % repeat units from isobutylene.

As used herein, at least one halogenated isobutylene based elastomer or polymer refers to those elastomers or polymers as described above that have undergone some halogenation process to comprise at least one halogen functional group, for example, bromine or chlorine. As noted here, this is not meant to exclude polymers made from one or more monomers comprising at least one halogen.

As used herein, hydrocarbon refers to molecules or segments of molecules containing primarily hydrogen and carbon atoms. In some embodiments, hydrocarbon also includes halogenated versions of hydrocarbons and versions containing heteroatoms as discussed in more detail below.

As used herein, rubber refers to any polymer or composition of polymers consistent with the ASTM D1566 definition: “a material that is capable of recovering from large deformations, and can be, or already is, modified to a state in which it is essentially insoluble (but can swell) in boiling solvent . . . .” Elastomer is a term that may be used interchangeably with the term rubber. Elastomer includes mixed blends of polymers such as melt mixing and/or reactor blends of polymers.

As used herein, elastomeric composition refers to any composition comprising at least one elastomer as defined above. A cured elastomeric composition or an article made from an elastomer or elastomeric composition refers to any elastomeric composition that has undergone a curing process and/or comprises or is produced using an effective amount of a curative or cure package as understood in the art.

As used herein, the elastomeric compositions may also include or be made from a variety of optional components such as at least one thermoplastic resin, at least one filler, at least one clay, and/or at least one modified layered filler such as an organically modified exfoliated clay, at least one processing aid, at least one additive, at least one curative, etc. as described in greater detail below. As noted here, the components may or may not be able to be detected to any appreciable amount or may be present in final composition in their derived form after processing. However, for simplicity, the elastomeric composition will be described as comprising, consisting essentially of, or consisting of (as appropriate) those components and what is meant here is to cover all embodiments where the elastomeric compositions are made from their respective components and those components understood in the art to have utility in the making of these compositions.

As used herein, a vulcanized rubber compound or composition refers to any composition consistent with the ASTM D1566 definition “a crosslinked elastic material compounded from an elastomer, susceptible to large deformations by a small force capable of rapid, forceful recovery to approximately its original dimensions and shape upon removal of the deforming force.”

As used herein, an effective amount of at least one halogenated isobutylene based elastomer and at least one secondary elastomer to impart a brittleness point (as herein defined) of −48° C. or less to an article refers to the relative ratios of the elastomers present in the elastomeric composition determined by a skilled artisan by routine experimentation to arrive at a brittleness point of −48° C. or less.

As used herein, phr is parts per hundred rubber, and is a measure common in the art wherein components of a composition are measured relative to a major elastomer component, based upon 100 parts by weight of the elastomer(s) or rubber(s).

As used herein, Tg refers to the transformation of the elastomer into a rigid plastic. It is also referred to as ‘glass-transition temperature’ or ‘glass point.’ This transformation occurs whether or not the elastomer is capable of crystallization. The Tg of natural rubber is about −72° C. The Tg of SBR is about −50° C., and polybutadienes exhibit Tg values as low as about −100° C., and are dependent upon the exact microstructures of these elastomers, e.g. the percentage of ‘cis’, ‘trans’ and ‘vinyl’ contents, or the amount of bound styrene. As is recognized in the art, although they are rigid solids when at temperatures when below Tg, elastomers are not true solids at these temperatures.

As used herein, mixture may refer to a physical blend or a reactor blend or any other composition produced from at least two units including but not limited to precursors or building blocks such as monomers. The term may also refer to a combination of units regardless of whether the constituents are in fixed proportions.

### Halogenated Isobutylene Based Elastomer

The composition of the present invention is an elastomeric composition comprising at least one halogenated isobutylene based elastomer or polymer. The at least one halogenated isobutylene based elastomer may be at least one halogenated butyl rubber, at least one halogenated star-branched butyl rubber, at least one halogenated random copolymer of isobutylene and methylstyrene (preferably para-methylstyrene), or mixtures thereof.

In one embodiment of the invention, the halogenated butyl rubber is a halogenated copolymer of a C₄ to C₆ isoolefin and a conjugated diene.

In another embodiment, the halogenated rubber component is a composition of a polydiene or block copolymer, and a copolymer of a C₄ to C₆ isoolefin and a conjugated, or a “star-branched” butyl polymer or a halogenated random copolymer of isobutylene and methylstyrene, wherein the at least one halogenated random copolymer includes at least 4.0 wt % methylstyrene, preferably para-methylstyrene, based upon the weight of the at least one halogenated random copolymer.

For example, the at least one halogenated random copolymer may also include at least 6.0 wt % methylstyrene, alternatively, at least 7.0 wt % methylstyrene, alternatively, at least 8.0 wt % methylstyrene, alternatively, at least 9.0 wt % methylstyrene, alternatively, at least 10.0 wt % methylstyrene, alternatively, at least 11.0 wt % methylstyrene, alternatively, at least 12.0 wt % methylstyrene, alternatively, at least 13.0 wt % methylstyrene, and alternatively, at least 15.0 wt % methylstyrene, preferably para-methylstyrene, for any of the aforementioned embodiments, based upon the weight of the at least one halogenated random copolymer. The random copolymer may be halogenated subsequent to polymerization by for example bromine or chlorine by methods well known in the art.

In one embodiment, the halogenated butyl rubber is brominated butyl rubber, and in another embodiment is chlorinated butyl rubber. General properties and processing of halogenated butyl rubbers are described in THE VANDERBILT RUBBER HANDBOOK, P 105-122 (Ohm ed., R.T. Vanderbilt Co., Inc. 1990), and in RUBBER TECHNOLOGY, P 311-321 (Morton ed., Chapman & Hall 1995). Butyl rubbers, halogenated butyl rubbers, and star-branched butyl rubbers are described by Kresge and Wang in 8 KIRK-OTHMER ENCYCLOPEDIA OF CHEMICAL TECHNOLOGY, P 934-955 (John Wiley & Sons, Inc. 4th ed. 1993).

The halogenated rubber component of the present invention includes, but is not limited to, brominated butyl rubber, chlorinated butyl rubber, star-branched polyisobutylene rubber, star-branched brominated butyl (polyisobutylene/isoprene copolymer) rubber; star-branched chlorinated butyl (polyisobutylene/isoprene copolymer) rubber; isobutylene-bromomethylstyrene copolymers such as isobutylene/meta-bromomethylstyrene, isobutylene/para-bromomethylstyrene, isobutylene/chloromethylstyrene, halogenated isobutylene cyclopentadiene, and isobutylene/para-chloromethylstyrene, and the like halomethylated aromatic interpolymers as in U.S. Pat. Nos. 4,074,035 and 4,395,506; halogenated isoprene and halogenated isobutylene copolymers, polychloroprene, and the like, and mixtures of any of the above. Some embodiments of the halogenated rubber component are also described in U.S. Pat. Nos. 4,703,091 and 4,632,963.

More particularly, in one embodiment of the brominated rubber component of the invention, a halogenated butyl rubber is used. The halogenated butyl rubber is produced from the halogenation of butyl rubber. Preferably, the olefin polymerization feeds employed in producing the halogenated butyl rubber of the invention are those olefinic compounds conventionally used in the preparation of butyl-type rubber polymers. In one embodiment, the butyl rubbers are prepared by reacting a comonomer mixture, the mixture having at least (1) a C₄ to C₆ isoolefin monomer component such as isobutylene with (2) a multiolefin, or conjugated diene, monomer component. The isoolefin is in a range from 70 to 99.5 wt % by weight of the total comonomer mixture in one embodiment, and 85 to 99.5 wt % in another embodiment. The conjugated diene component in one embodiment is present in the comonomer mixture from 30 to 0.5 wt % in one embodiment, and from 15 to 0.5 wt % in another embodiment. In yet another embodiment, from 8 to 0.5 wt % of the comonomer mixture is conjugated diene. In another embodiment, a homopolymer of either (1) or (2) is produced, which can then be halogenated.

The isoolefin is a C₄ to C₆ compound such as isobutylene, isobutene 2-methyl-1-butene, 3-methyl-1-butene, 2-methyl-2-butene, and 4-methyl-1-pentene. The multiolefin is a C₄ to C₁₄ conjugated diene such as isoprene, butadiene, 2,3-dimethyl-1,3-butadiene, myrcene, 6,6-dimethyl-fulvene, cyclopentadiene, hexadiene and piperylene. One embodiment the butyl rubber polymer of the invention is obtained by reacting 92 to 99.5 wt % of isobutylene with 0.5 to 8 wt % isoprene, or reacting 95 to 99.5 wt % isobutylene with from 0.5 wt % to 5.0 wt % isoprene in yet another embodiment.

Butyl rubbers and methods of their production are described in detail in, for example, U.S. Pat. Nos. 2,356,128, 3,968,076, 4,474,924, 4,068,051 and 5,532,312. Butyl rubber may be prepared by a slurry polymerization, typically in a diluent comprising a halogenated hydrocarbon(s) such as a chlorinated hydrocarbons and/or a fluorinated hydrocarbons including mixtures thereof, (see e.g., WO 2004/058828, WO 2004/058827, WO 2004/058835, WO 2004/058836, WO 2004/058825, WO 2004/067577, and WO 2004/058829), of the monomer mixture using a Lewis acid catalyst, followed by halogenation, preferably bromination or chlorination, in solution in the presence of halogen and a radical initiator such as heat and/or light and/or a chemical initiator.

Halogenated butyl rubber is produced by the halogenation of the butyl rubber product described above. Halogenation can be carried out by any means, and the invention is not herein limited by the halogenation process. Methods of halogenating polymers such as butyl polymers are disclosed in U.S. Pat. Nos. 2,631,984, 3,099,644, 4,554,326, 4,681,921, 4,650,831, 4,384,072, 4,513,116 and 5,681,901. In one embodiment, the butyl rubber is halogenated in hexane diluent at from 4 to 60° C. using bromine (Br₂) or chlorine (Cl₂) as the halogenation agent. The halogenated butyl rubber has a Mooney Viscosity of from 20 to 70 (ML 1+8 at 125° C.) in one embodiment, and from 25 to 55 in another embodiment. The halogen wt % is from 0.1 to 10 wt % based in on the weight of the halogenated butyl rubber in one embodiment, and from 0.5 to 5 wt % in another embodiment. In yet another embodiment, the halogen wt % of the halogenated butyl rubber is from 1 to 2.5 wt %.

A commercial embodiment of the halogenated butyl rubber of the present invention is Bromobutyl 2222 (ExxonMobil Chemical Company, Houston, Tex.). Its Mooney Viscosity is from 27 to 37 (ML 1+8 at 125° C., ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084). Another commercial embodiment of the halogenated butyl rubber is Bromobutyl 2255 (ExxonMobil Chemical Company, Houston, Tex.). Its Mooney Viscosity is from 41 to 51 (ML 1+8 at 125° C., ASTM D1646), and the bromine content is from 1.8 to 2.2 wt %. Further, cure characteristics of Bromobutyl 2255 are as follows: MH is from 34 to 48 dN·m, ML is from 11 to 21 dN·m (ASTM D2084).

Other suitable commercial grades of butyl rubbers and halobutyl rubbers are available from Lanxess Corporation (Pittsburgh, Pa.).

In another embodiment of the brominated rubber component of the invention, a branched or “star-branched” halogenated butyl rubber is used. In one embodiment, the halogenated star-branched butyl rubber (“HSSB”) is a composition of a butyl rubber, either halogenated or not, and a polydiene or block copolymer, either halogenated or not. The halogenation process is described in detail in U.S. Pat. Nos. 4,074,035, 5,071,913, 5,286,804, 5,182,333 and 6,228,978. The invention is not limited by the method of forming the HSSB. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the HSSB. The branching agent or polydiene can be any suitable branching agent, and the invention is not limited to the type of polydiene used to make the HSSB.

In one embodiment, the HSSB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the HSSB of the present invention is Bromobutyl 6222 (ExxonMobil Chemical Company, Houston, Tex.), having a Mooney Viscosity (ML 1+8 at 125° C., ASTM D1646) of from 27 to 37, and a bromine content of from 2.2 to 2.6 wt % relative to the HSSB. Further, cure characteristics of Bromobutyl 6222 are as follows: MH is from 24 to 38 dN·m, ML is from 6 to 16 dN·m (ASTM D2084).

Embodiments of the present invention include an elastomeric composition comprising at least one random copolymer comprising a C₄ to C₇ isomonoolefin. The at least one random copolymer may be halogenated with, for example, bromine or chlorine. In an embodiment, the at least one random copolymer is poly(isobutylene-co-p-alkylstyrene) comprising at least 4 wt % p-alkylstyrene, such as p-methylstyrene, based upon the total weight of the at least one random copolymer.

### Secondary Elastomer

The elastomeric composition also includes a secondary elastomer. To afford a balance of properties useful in the manufacture of air barriers such as tire innerliners for tires, an appropriate secondary elastomer may be used in combination with the at least one halogenated isobutylene based elastomer to maintain the performance of the end use article such as in service tire performance. Useful properties to consider for manufacturing include, but are not limited to, the ease of mixing, sheeting by milling, calendering or extruding, and tire building and curing. Thus, compound Mooney viscosity, Mooney scorch and curing characteristics are important properties. As for in-service tire performance, it is dependent upon, but not limited to, innerliner air retention, flex fatigue retention, and adhesion to adjacent components in the cured tire.

In an embodiment, the secondary elastomer comprises at least one polybutadiene (BR) rubber. The Mooney viscosity of the polybutadiene rubber as measured at 100° C. (ML 1+4) may range from 30 to 70, from 35 to about 65 in another embodiment, and from 40 to 60 in yet another embodiment.

In an embodiment, the polybutadiene is a ‘high cis-polybutadiene’ (cis-BR). By “cis-polybutadiene” or “high cis-polybutadiene”, it is meant that 1,4-cis polybutadiene is used, wherein the amount of cis isomeric component is at least 90% in one embodiment, at least 95% in another embodiment, and at least 98% in yet another embodiment. Examples of these synthetic rubbers are BUDENE™ 1207 rubber (BR 1207) or BUDENE™ 1208 rubber (BR 1208) and the like (Goodyear Chemical Company, Akron, Ohio); and BUNA™ CB 22 rubber or BUNA™ CB 23 rubber or BUNA™ CB 24 rubber or BUNA™ CB 25 rubber and the like (Lanxess Corporation, Pittsburgh, Pa.); and Diene 635 rubber or Diene 645 rubber and the like (Firestone Polymers LLC, Akron, Ohio).

In certain embodiments, the polybutadiene has a low glass transition temperatures wherein the Tg is lower than −70° C. in one embodiment, lower than −80° C. in another embodiment, lower than −90° C. in yet another embodiment. Examples of these synthetic rubbers useful in the present invention are for example BUDENE™ 1207; and BUNA™ CB 24 or TAKTENE™ 1203 G1 rubber, TAKTENE™ 220 rubber, TAKTENE™ 221 rubber, TAKTENE™ 4510 rubber, TAKTENE™ 5510 rubber and the like (Lanxess Inc., Samia, Ontario, Canada); and Diene 635.

An example of high cis-polybutadiene is BUDENE™ 1207 or BUNA™ CB 23.

In yet other embodiments, the elastomeric composition may also comprise a polyisoprene (IR) rubber as the secondary elastomer. The Mooney viscosity of the polyisoprene rubber as measured at 100° C. (ML 1+4) may range from 35 to 70, from 40 to about 65 in another embodiment, and from 45 to 60 in yet another embodiment. In another embodiment, the polyisoprene is a cis polyisoprene.

In certain embodiments, the polyisoprene rubber has a low glass transition temperatures wherein the Tg is lower than −70° C. in one embodiment, lower than −80° C. in another embodiment, lower than −90° C. in yet another embodiment. A commercial example of these synthetic rubbers useful in the present invention is NATSYN™ 2200 (Goodyear Chemical Company, Akron, Ohio).

Thus, in certain embodiments, by selecting the appropriate secondary elastomer with an effective amount of the at least one halogenated isobutylene based elastomer, an article such as an innerliner for a tire may be produced from a process that retains all or a majority of the desired manufacturing characteristics while extending the useful service of the article to extreme or inclement weather conditions by reducing, for example, the brittleness temperature of the article.

### Other Polymers and Polymeric Systems

In other embodiments, the elastomeric compositions may also include other polymers and/or elastomers or rubbers such as “general purpose rubbers.”

A general purpose rubber, often referred to as a commodity rubber, may be any rubber that usually provides high strength and good abrasion along with low hysteresis and high resilience. These elastomers require antidegradants in the mixed compound because they generally have poor resistance to both heat and ozone. They are often easily recognized in the market because of their low selling prices relative to specialty elastomers and their big volumes of usage as described by School in RUBBER TECHNOLOGY COMPOUNDING AND TESTING FOR PERFORMANCE, p 125 (Dick, ed., Hanser, 2001).

Examples of general purpose rubbers include natural rubbers (NR), polyisoprene rubber (IR), poly(styrene-co-butadiene) rubber (SBR), polybutadiene rubber (BR), poly(isoprene-co-butadiene) rubber (IBR), and styrene-isoprene-butadiene rubber (SIBR), and mixtures thereof. Ethylene-propylene rubber (EPM) and ethylene-propylene-diene rubber (EPDM), and their mixtures, often are also referred to as general purpose elastomers.

In another embodiment, the composition may also comprise a natural rubber. Natural rubbers are described in detail by Subramaniam in RUBBER TECHNOLOGY, P 179-208 (Morton, ed., Chapman & Hall, 1995). Desirable embodiments of the natural rubbers of the present invention are selected from Malaysian rubber such as SMR CV, SMR 5, SMR 10, SMR 20, and SMR 50 and mixtures thereof, wherein the natural rubbers have a Mooney viscosity at 100° C. (ML 1+4) of from 30 to 120, more preferably from 40 to 65. The Mooney viscosity test referred to herein is in accordance with ASTM D1646.

In another embodiment, the composition may also comprise rubbers of ethylene and propylene derived units such as EPM and EPDM as suitable additional rubbers. Examples of suitable comonomers in making EPDM are ethylidene norbornene, 1,4-hexadiene, dicyclopentadiene, as well as others. These rubbers are described in RUBBER TECHNOLOGY, P 260-283 (1995). A suitable ethylene-propylene rubber is commercially available as VISTALON™ specialty polymer (ExxonMobil Chemical Company, Houston, Tex.).

In another embodiment, the composition may comprise a so called semi-crystalline copolymer (“SCC”). Semi-crystalline copolymers are described in WO 00/69966. Generally, the SCC is a copolymer of ethylene or propylene derived units and α-olefin derived units, the α-olefin having from 4 to 16 carbon atoms in one embodiment, and in another embodiment the SCC is a copolymer of ethylene derived units and α-olefin derived units, the α-olefin having from 4 to 10 carbon atoms, wherein the SCC has some degree of crystallinity, and in some embodiments has crystallizable propylene sequences. In a further embodiment, the SCC is a copolymer of 1-butene derived units and another α-olefin derived unit, the other α-olefin having from 5 to 16 carbon atoms, wherein the SCC also has some degree of crystallinity. In certain embodiments, the SCC generally comprises from about 60 to about 96 weight percents units derived from propylene and from about 40 to about 4 weight percent units derived from an α-olefin such as ethylene. The SCC may optionally comprise units derived from at least one diene. Commercial examples include VISTAMAXX specialty polymer (ExxonMobil Chemical Company, Houston, Tex.) and VERSIFY specialty polymer (Dow Chemical Company, Midland, Mich.).

The elastomer(s) as described above may be present in the elastomeric composition in a range from up to 30 phr in one embodiment, from up to 25 phr in another embodiment, from up to 20 phr in another embodiment, and from up to 15 phr in yet another embodiment. In yet another embodiment, the elastomer may be present from at least 2 phr, and from at least 3 phr in another embodiment, and from at least 5 phr in yet another embodiment, and from at least 10 phr in yet another embodiment. A desirable embodiment may include any combination of any upper phr limit and any lower phr limit.

For example, the elastomer, either individually or as a blend of rubbers may be present in the composition from 2 phr to 30 phr in one embodiment, and from 3 phr to 25 phr in another embodiment, and from 5 to 20 phr in yet another embodiment, and from 10 to 20 phr in yet another embodiment, and from 3 to 30 phr in yet another embodiment, and from 5 to 25 phr in yet another embodiment, and from 5 to 30 phr in yet another embodiment, and from 10 to 30 phr in yet another embodiment, and from 10 to 25 phr in yet another embodiment, the chosen embodiment depending upon the desired end use application of the composition.

### Thermoplastic Resin

The elastomeric compositions may optionally include a thermoplastic resin. Thermoplastic resins suitable for practice of the present invention may be used singly or in combination and are resins containing nitrogen, oxygen, halogen, sulfur or other groups capable of interacting with aromatic functional groups such as halogen or acidic groups. The resins are present from 30 to 90 wt % in one embodiment, and from 40 to 80 wt % in another embodiment, and from 50 to 70 wt % in yet another embodiment. In yet another embodiment, the resin is present at a level of greater than 40 wt %, and greater than 60 wt % in another embodiment.

Suitable thermoplastic resins include resins selected from the group consisting or polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK) and mixtures thereof.

Suitable thermoplastic polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6, 10), polyhexamethyleneisophthalamide (nylon-6, IP) and the condensation product of 11-amino-undecanoic acid (nylon-11). Additional examples of satisfactory polyamides (especially those having a softening point below 275° C.) are described in 16 ENCYCLOPEDIA OF CHEMICAL TECHNOLOGY, P 1-105 (John Wiley & Sons 1968), CONCISE ENCYCLOPEDIA OF POLYMER SCIENCE AND TECHNOLOGY, P 748-761 (John Wiley & Sons, 1990), and 10 ENCYCLOPEDIA OF POLYMER SCIENCE AND TECHNOLOGY, P 392-414 (John Wiley & Sons 1969). Commercially available thermoplastic polyamides may be advantageously used in the practice of this invention, with linear crystalline polyamides having a softening point or melting point between 160 and 260° C. being preferred.

Suitable thermoplastic polyesters which may be employed include the polymer reaction products of one or a mixture of aliphatic or aromatic polycarboxylic acids esters of anhydrides and one or a mixture of diols. Examples of satisfactory polyesters include poly(trans-1,4-cyclohexylene C₂₋₆ alkane dicarboxylates such as poly(trans-1,4-cyclohexylene succinate) and poly(trans-1,4-cyclohexylene adipate); poly(cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly(C₂₋₄ alkylene terephthalates) such as polyethyleneterephthalate and polytetramethylene-terephthalate, poly(C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Poly(phenylene ether) (PPE) thermoplastic resins which may be used in accordance with this invention are well known, commercially available materials produced by the oxidative coupling polymerization of alkyl substituted phenols. They are generally linear, amorphous polymers having a glass transition temperature in the range of 190° C. to 235° C. These polymers, their method of preparation and compositions with polystyrene are further described in U.S. Pat. No. 3,383,435.

Other thermoplastic resins which may be used include the polycarbonate analogs of the polyesters described above such as segmented poly (ether co-phthalates); polycaprolactone polymers; styrene resins such as copolymers of styrene with less than 50 mol % of acrylonitrile (SAN) and resinous copolymers of styrene, acrylonitrile and butadiene (ABS); sulfone polymers such as polyphenyl sulfone; copolymers and homopolymers of ethylene and C₂ to C₈ α-olefins, in one embodiment a homopolymer of propylene derived units, and in another embodiment a random copolymer or block copolymer of ethylene derived units and propylene derived units, and like thermoplastic resins as are known in the art.

In yet another embodiment, the elastomeric compositions may also be employed to produce a thermoplastic elastomer. A thermoplastic elastomer as used herein refers to compositions consistent with ASTM D1566 referring to a rubber-like material “that repeatedly can be softened by heating and hardened by cooling through a temperature range characteristic of the polymer, and in the softened state can be shaped into articles.” Thermoplastic elastomers are microphase separated systems of at least two polymers. One phase is the hard polymer that does not flow at room temperature, but becomes fluid when heated, that gives thermoplastic elastomers its strength. The other phase is a soft rubbery polymer that gives thermoplastic elastomers their elasticity. The hard phase is typically the major or continuous phase.

The elastomeric compositions may also be used to produce a thermoplastic vulcanizate. A thermoplastic vulcanizate refers to any composition consistent with ASTM D1566 referring to “a thermoplastic elastomer with a chemically cross-linked rubbery phase, produced by dynamic vulcanization.” Dynamic vulcanization is “the process of intimate melt mixing of a thermoplastic polymer and a suitable reactive rubbery polymer to generate a thermoplastic elastomer with a chemically cross-linked rubbery phase . . . .”

### Fillers

The elastomeric composition may have one or more filler components. For ease of reference, materials described herein and their equivalents will be referred to as filler(s). Examples include but are not limited to calcium carbonate, clay, mica, silica and silicates, talc, titanium dioxide, starch and other organic fillers such as wood flower, and carbon black. In one embodiment, the filler is carbon black or modified carbon black.

A specific example includes a semi-reinforcing grade carbon black present at a level of from 10 to 150 phr of the composition, alternatively, from 30 to 180 phr, alternatively, 60 to 180 phr, alternatively, 80 to 180 phr, and alternatively, 60 to 120 phr. In other embodiments, the carbon black is present at levels of 60 phr or more, alternatively, 80 phr or more, and alternatively, 100 phr or more. Useful grades of carbon black as described in RUBBER TECHNOLOGY 59-85 (1995) range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762. Embodiments of the carbon black useful in, for example, innerliners or innertubes are N550, N650, N660, N762, N990, and Regal 85 (Cabot Corporation, Alpharetta, Ga.) and the like.

The filler may also be a modified clay or be combined with a modified clay, such as an exfoliated clay. The layered filler may comprise a layered clay pre-treated with organic molecules.

Layered clays include at least one silicate.

In certain embodiments, the silicate may comprise at least one “smectite” or “smectite-type clay” referring to the general class of clay minerals with expanding crystal lattices. For example, this may include the dioctahedral smectites which consist of montmorillonite, beidellite, and nontronite, and the trioctahedral smectites, which includes saponite, hectorite, and sauconite. Also encompassed are smectite-clays prepared synthetically, e.g., by hydrothermal processes as disclosed in U.S. Pat. Nos. 3,252,757, 3,586,468, 3,666,407, 3,671,190, 3,844,978, 3,844,979, 3,852,405, and 3,855,147.

In yet other embodiments, the at least one silicate may comprise natural or synthetic phyllosilicates, such as montmorillonite, nontronite, beidellite, bentonite, volkonskoite, laponite, hectorite, saponite, sauconite, magadite, kenyaite, stevensite and the like, as well as vermiculite, halloysite, aluminate oxides, hydrotalcite, and the like. Combinations of any of the previous embodiments are also contemplated.

The layered clay may be intercalated and exfoliated by treatment with organic molecules such as swelling or exfoliating agents or additives capable of undergoing ion exchange reactions with the cations present at the interlayer surfaces of the layered silicate. Suitable exfoliating additives include cationic surfactants such as ammonium, alkylamines or alkylammonium (primary, secondary, tertiary and quaternary), phosphonium or sulfonium derivatives of aliphatic, aromatic or arylaliphatic amines, phosphines and sulfides.

For example, amine compounds (or the corresponding ammonium ion) are those with the structure R²R³R⁴N, wherein R², R³, and R⁴ are C₁ to C₃₀ alkyls or alkenes in one embodiment, C₁ to C₂₀ alkyls or alkenes in another embodiment, which may be the same or different. In one embodiment, the exfoliating agent is a so-called long chain tertiary amine, wherein at least R² is a C₁₄ to C₂₀ alkyl or alkene.

In other embodiments, a class of exfoliating additives include those which can be covalently bonded to the interlayer surfaces. These include polysilanes of the structure —Si(R⁵)₂R⁶ where R⁵ is the same or different at each occurrence and is selected from alkyl, alkoxy or oxysilane and R⁶ is an organic radical compatible with the matrix polymer of the composite.

Other suitable exfoliating additives include protonated amino acids and salts thereof containing 2-30 carbon atoms such as 12-aminododecanoic acid, epsilon-caprolactam and like materials. Suitable swelling agents and processes for intercalating layered silicates are disclosed in U.S. Pat. Nos. 4,472,538, 4,810,734, and 4,889,885 and WO92/02582.

In an embodiment, the exfoliating additive or additives are capable of reacting with the halogen sites of the halogenated elastomer to form complexes which help exfoliate the clay. In certain embodiments, the additives include all primary, secondary and tertiary amines and phosphines; alkyl and aryl sulfides and thiols; and their polyfunctional versions. Desirable additives include: long-chain tertiary amines such as N,N-dimethyl-octadecylamine, N,N-dioctadecyl-methylamine, so called dihydrogenated tallowalkyl-methylamine and the like, and amine-terminated polytetrahydrofuran; long-chain thiol and thiosulfate compounds like hexamethylene sodium thiosulfate.

The exfoliating additive such as described herein is present in the composition in an amount to achieve optimal air retention as measured by the permeability testing described herein. For example, the additive may be present from 0.1 to 40 phr in one embodiment, and from 0.2 to 20 phr in yet another embodiment, and from 0.3 to 10 phr in yet another embodiment.

The exfoliating additive may be added to the composition at any stage; for example, the additive may be added to the elastomer, followed by addition of the layered filler, or may be added to a combination of at least one elastomer and at least one layered filler; or the additive may be first blended with the layered filler, followed by addition of the elastomer in yet another embodiment.

In certain embodiments, treatment with the swelling agents described above results in intercalation or exfoliation of the layered platelets as a consequence of a reduction of the ionic forces holding the layers together and introduction of molecules between layers which serve to space the layers at distances of greater than 4 Å, alternatively greater than 9 Å. This separation allows the layered silicate to more readily sorb polymerizable monomer material and polymeric material between the layers and facilitates further delamination of the layers when the intercalate is shear mixed with matrix polymer material to provide a uniform dispersion of the exfoliated layers within the polymer matrix.

In certain embodiments, the layered filler comprises alkyl ammonium salts-intercalated clay. Commercial products are available as Cloisites produced by Southern Clay Products, Inc. (Gunsalas, Tex.). For example, Cloisite Na⁺, Cloisite 30B, Cloisite 10A, Cloisite 25A, Cloisite 93A, Cloisite 20A, Cloisite 15A, and Cloisite 6A. They are also available as SOMASIF and LUCENTITE clays produced by CO-OP Chemical Co., LTD (Tokyo, Japan). For example, SOMASIF™ MAE, SOMASIF™ MEE, SOMASIF™ MPE, SOMASIF™ MTE, SOMASIJF™ ME-100, LUCENTITE™ SPN, and LUCENTITE (SWN).

In certain embodiments, the layered filler generally comprise particles containing a plurality of silicate platelets having a thickness of 8-12 Å tightly bound together at interlayer spacings of 4 Å or less, and contain exchangeable cations such as Na⁺, Ca⁺², K⁺ or Mg⁺² present at the interlayer surfaces.

More recently, modifying agents also include polymer chains with functionalized units. For example, suitable modifying agents may comprise at least one polymer chain E comprising a carbon chain length of from C₂₅ to C₅₀₀, wherein the polymer chain also comprises an ammonium-functionalized group described by the following group pendant to the polymer chain E:

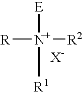

wherein each R, R¹ and R² are the same or different and independently selected from hydrogen, C₁ to C₂₆ alkyl, alkenes or aryls, substituted C₁ to C₂₆ alkyls, alkenes or aryls, C₁ to C₂₆ aliphatic alcohols or ethers, C₁ to C₂₆ carboxylic acids, nitrites, ethoxylated amines, acrylates and esters; and wherein X is a counterion of ammonium such as Br⁻, Cl⁻ or PF₆⁻.

The modifying agent may also comprise at least one additional agent capable of undergoing ion exchange reactions with the cations present at the interlayer surfaces of the layered filler.

In other embodiments, the polymer chain may comprise a carbon chain length of from C₃₀ to C₄₀₀, preferably C₃₀ to C₃₀₀, and even more preferably C₃₀ to C₂₀₀.

In an embodiment, the polymer chain comprises isobutylene derived units with the ammonium-functionalized group as described above. In another embodiment, the polymer chain may consist essentially of poly(isobutylene) with the ammonium-functionalized group as described above. In yet another embodiment, the modifying agent may comprise at least one end-functionalized polyisobutylene amine.

### Processing Aids and Additives

A processing oil may be present in blends or compositions of the invention. The processing oil may be selected from paraffinic oil, aromatic oils, naphthenic oils, and polybutene, polyalphaolefin, and plastomer processing aids.

Distinctly, the polybutene processing aid is a low molecular weight (less than 15,000 Mn) homopolymer or copolymer of olefin derived units having from 3 to 8 carbon atoms, more preferably 4 to 6 carbon atoms. In yet another embodiment, the polybutene is a homopolymer or copolymer of a C₄ raffinate. Such low molecular weight polymers termed “polybutene” polymers is described in, for example, SYNTHETIC LUBRICANTS AND HIGH-PERFORMANCE FUNCTIONAL FLUIDS, P 357-392 (Rudnick & Shubkin, eds., Marcel Dekker, 1999) (hereinafter “polybutene processing aid” or “polybutene”). Examples of such a processing aid are the PARAPOL™ series of processing aids (ExxonMobil Chemical Company, Houston, Tex.), such as PARAPOL™ 450, 700, 950, 1300, 2400, and 2500. The PARAPOL™ series of polybutene processing aids are typically synthetic liquid polybutenes, each individual formulation having a certain molecular weight, all formulations of which can be used in the composition. The molecular weights of the PARAPOL™ oils are from 420 Mn (PARAPOL™ 450) to 2700 Mn (PARAPOL™ 2500). The MWD of the PARAPOL™ oils range from 1.8 to 3, preferably 2 to 2.8. The density (g/ml) of PARAPOL™ oils varies from about 0.85 (PARAPOL™ 450) to 0.91 (PARAPOL™ 2500). The bromine number (CG/G) for PARAPOL™ oils ranges from 40 for the 450 Mn oil, to 8 for the 2700 Mn oil.

In another embodiment, the processing aid may comprise polyalphaolefins (PAOs), high purity hydrocarbon fluid compositions (HPFCs) and/or Group III basestocks such as those described in WO 2004/014998 at page 16, line 14 to page 24, line 1. Examples of PAOs include oligomers of decene and co-oligomers of decene and dodecene. Preferred PAOs are available under the trade name SuperSyn™ PAO (ExxonMobil Chemical Company, Houston, Tex.).

In yet another embodiment, the processing aid may comprise plastomers, polyolefin copolymers, having a density of from 0.85 to 0.915 g/cm³ and a melt index (MI) between 0.10 and 30 dg/min. Examples of the useful plastomer is a copolymer of ethylene derived units and at least one of C₃ to C₁₀ α-olefin derived units, the copolymer having a density in the range of less than 0.915 g/cm³. The amount of comonomer (C₃ to C₁₀ α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

The plastomer useful in the invention has a melt index (MI) of between 0.10 and 20 dg/min (ASTM D1238; 190° C., 2.1 kg) in one embodiment, and from 0.2 to 10 dg/min in another embodiment, and from 0.3 to 8 dg/min in yet another embodiment. The average molecular weight of useful plastomers ranges from 10,000 to 800,000 in one embodiment, and from 20,000 to 700,000 in another embodiment. The 1% secant flexural modulus (ASTM D790) of useful plastomers ranges from 10 MPa to 150 MPa in one embodiment, and from 20 MPa to 100 MPa in another embodiment. Further, the plastomer that is useful in compositions of the present invention has a melting temperature (Tm) of from 50 to 62° C. (first melt peak) and from 65 to 85° C. (second melt peak) in one embodiment, and from 52 to 60° C. (first melt peak) and from 70 to 80° C. (second melt peak) in another embodiment.

Plastomers useful in the present invention are metallocene catalyzed copolymers of ethylene derived units and higher α-olefin derived units such as propylene, 1-butene, 1-hexene and 1-octene, and which contain enough of one or more of these comonomer units to yield a density between 0.860 and 0.900 g/cm³ in one embodiment. The molecular weight distribution (Mw/Mn) of desirable plastomers ranges from 2 to 5 in one embodiment, and from 2.2 to 4 in another embodiment. Examples of a commercially available plastomers are EXACT 4150, a copolymer of ethylene and 1-hexene, the 1-hexene derived units making up from 18 to 22 wt % of the plastomer and having a density of 0.895 g/cm³ and MI of 3.5 dg/min (ExxonMobil Chemical Company, Houston, Tex.); and EXACT 8201, a copolymer of ethylene and 1-octene, the 1-octene derived units making up from 26 to 30 wt % of the plastomer, and having a density of 0.882 g/cm³ and MI of 1.0 dg/min (ExxonMobil Chemical Company, Houston, Tex.).

For example, the processing aid, either individually or as a blend may be present in the composition from 2 phr to 50 phr in one embodiment, and from 3 phr to 40 phr in another embodiment, and from 3 to 30 phr in yet another embodiment, and from 3 to 25 phr in yet another embodiment, and from 3 to 20 phr in yet another embodiment, and from 3 to 50 phr in yet another embodiment, and from 2 to 40 phr in yet another embodiment, and from 4 to 50 phr in yet another embodiment, and from 5 to 50 phr in yet another embodiment, the chosen embodiment depending upon the desired end use application of the composition.

### Curing Agents and Accelerators

The compositions produced in accordance with the present invention typically contain other components and additives customarily used in rubber mixes, such as pigments, accelerators, cross-linking and curing materials, antioxidants, antiozonants, and fillers. In one embodiment, processing aids (resins) such as naphthenic, aromatic or paraffinic extender oils may be present from 1 to 30 phr. In another embodiment, naphthenic, aliphatic, paraffinic and other aromatic resins and oils are substantially absent from the composition. By “substantially absent”, it is meant that naphthenic, aliphatic, paraffinic and other aromatic resins are present, if at all, to an extent no greater than 2 phr in the composition.

Generally, polymer compositions, e.g., those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilizationfor NR, RUBBER WORLD, p 18-23 (1991)). Cross-linking and curing agents include sulfur, zinc oxide, and fatty acids. Peroxide cure systems may also be used. Generally, polymer compositions may be crosslinked by adding curative molecules, for example sulfur, metal oxides (i.e., zinc oxide), organometallic compounds, radical initiators, etc. followed by heating. In particular, the following are common curatives that will function in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and Al(Stearate)₃), or with stearic acid, and either a sulfur compound or an alkylperoxide compound. (See also, Formulation Design and Curing Characteristics of NBR Mixes for Seals, RUBBER WORLD, P 25-30 (1993)). This method may be accelerated and is often used for the vulcanization of elastomer compositions.

Accelerators include amines, guanidines, thioureas, thiazoles, thiurams, sulfenamides, sulfenimides, thiocarbamates, xanthates, and the like. Acceleration of the cure process may be accomplished by adding to the composition an amount of the accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N,N′-diethyl thiourea.

In one embodiment of the invention, at least one curing agent is present from 0.2 to 15 phr, and from 0.5 to 10 phr in another embodiment. Curing agents include those components described above that facilitate or influence the cure of elastomers, such as metals, accelerators, sulfur, peroxides, and other agents common in the art, and as described above.

### Processing

Blends of elastomers may be reactor blends and/or melt mixes. Mixing of the components may be carried out by combining the polymer components, filler and the clay in the form of an intercalate in any suitable mixing device such as a Banbury™ mixer, Brabender™ mixer or preferably a mixer/extruder. Mixing is performed at temperatures in the range from up to the melting point of the elastomer and/or secondary rubber used in the composition in one embodiment, from 40° C. up to 250° C. in another embodiment, and from 100° C. to 200° C. in yet another embodiment, under conditions of shear sufficient to allow the clay intercalate to exfoliate and become uniformly dispersed within the polymer to form the nanocomposite.

Mixing may be performed in a BR Banbury™ internal mixer with, for example, tangential rotors, or, a Krupp internal mixer with, for example, intermeshing rotors, by techniques known in the art. Typically, from 70% to 100% of the elastomer or elastomers is first mixed for 20 to 90 seconds, or until the temperature reaches from 40° C. to 60° C. Then, ¾ of the filler, and the remaining amount of elastomer, if any, is typically added to the mixer, and mixing continues until the temperature reaches from 90 to 150° C. Next, the remaining filler is added, as well as the processing oil, and mixing continues until the temperature reaches from 140 to 190° C. The finished mixture is then finished by sheeting on an open mill and allowed to cool, for example, to from 60° C. to 100° C. when the curatives are added.

Mixing with the clays is performed by techniques known to those skilled in the art, wherein the clay is added to the polymer at the same time as the carbon black in one embodiment. The polybutene processing oil is typically added later in the mixing cycle after the carbon black and clay have achieved adequate dispersion in the elastomeric matrix.

The cured compositions of the invention can include various elastomers and fillers with the polybutene processing oil. The compositions of the invention typically include isobutylene-based elastomers such as halogenated poly(isobutylene-co-p-methylstyrene), butyl rubber, or halogenated star-branched butyl rubber (HSBB) either alone, or some combination with one another, with the polybutene processing oil being present from 5 to 30 phr in one embodiment.

In one embodiment, the composition is halogenated butyl rubber component from 70 to 97 phr that may include a general purpose rubber from 3 to 30 phr, and processing aid present from 3 to 30 phr, a filler such as a carbon black from 20 to 100 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 10 phr.

In another embodiment, the composition may be a halogenated butyl rubber component from 75 to 97 phr in one embodiment, and from 80 to 97 phr in another embodiment, and processing aid present from 3 to 30 phr, a filler such as a carbon black from 20 to 100 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 10 phr.

In yet another embodiment, the composition may be a halogenated butyl rubber component from 85 to 97 phr in one embodiment, and from 90 to 97 phr in another embodiment, and processing aid present from 3 to 30 phr, a filler such as a carbon black from 20 to 100 phr, and an exfoliating clay from 0.5 to 20 phr in one embodiment, and from 2 to 15 phr in another embodiment. The cure agents such as phenolic resins, sulfur, stearic acid, and zinc oxide, may be present from 0.1 to 10 phr.

The isobutylene-based elastomer useful in the invention can be blended with various other rubbers or plastics as disclosed herein, in particular thermoplastic resins such as nylons or polyolefins such as polypropylene or copolymers of polypropylene. These compositions are useful in air barriers such as bladders, innertubes, tire innerliners, air sleeves (such as in air shocks), diaphragms, as well as other applications where high air or oxygen retention is desirable.

For example, articles made from the elastomeric compositions have an air (air, oxygen, or nitrogen at 60° C.) permeabilities from about 1.2×10⁻⁸ to about 4×10⁻⁸ cm³-cm/cm²-sec-atm, and from about 1.5×10⁻⁸ to about 3.5×10⁻⁸ cm³-cm/cm²-sec-atm in another embodiment.

In one embodiment, the invention provides for an article comprising a composition comprising an effective amount of the at least one halogenated random copolymer to impart to the article a MOCON (as herein defined) of 37.5 cc-mil/m²-day-mmHg or lower, in another embodiment a MOCON of 35 cc-mil/m²-day-mmHg or lower, in yet another embodiment a MOCON of 32.5 cc-mil/m²-day-mmHg or lower, and in yet another embodiment a MOCON of 30 cc-mil/m²-day-mmHg or lower.

In one embodiment, an air barrier can be made by the method of combining at least one random copolymer comprising a C₄ to C₇ isomonoolefin derived unit, at least one filler, and polybutene oil having a number average molecular weight greater than 400, and at least one cure agent; and curing the combined components as described above.

### INDUSTRIAL APPLICABILITY

The blends of the invention may be extruded, compression molded, blow molded, injection molded, and laminated into various shaped articles including fibers, films, layers, industrial parts such as automotive parts, appliance housings, consumer products, packaging, and the like.

In addition, the blends are useful in articles for a variety of tire applications such as truck tires, bus tires, automobile tires, motorcycle tires, off-road tires, aircraft tires, and the like. The blends may either serve as a material fabricated into a finished article or a component of a finished article such as an innerliner for a tire. The article may be selected from air barriers, air membranes, films, layers (microlayers and/or multilayers), innerliners, innertubes, treads, bladders, sidewalls, and the like.

All patents and patent applications, test procedures (such as ASTM methods), and other documents cited herein are fully incorporated by reference to the extent such disclosure is consistent with this invention and for all jurisdictions in which such incorporation is permitted.

When numerical lower limits and numerical upper limits are listed herein, ranges from any lower limit to any upper limit are contemplated.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

### TEST METHODS AND EXAMPLES

Test methods are summarized in Table 1.

Cure properties were measured using an ODR 2000 and 1 or 3 degree arc, or a MDR 2000 and 0.5 degree arc at the indicated temperature. Test specimens were cured at the indicated temperature, typically from 150° C. to 160° C., for a time corresponding to t90+appropriate mold lag. The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “t” are cure times in minutes, and “ts” is scorch time” in minutes.

When possible, standard ASTM tests were used to determine the cured compound physical properties (see Table 1). Stress/strain properties (tensile strength, elongation at break, modulus values, energy to break) were measured at room temperature using an Instron 4202 or an Instron Series IX Automated Materials Testing System 6.03.08. Tensile measurements were done at ambient temperature on specimens (dog-bone shaped) width of 0.25 inches (0.62 cm) and a length of 1.0 inches (2.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in Tensile measurements is ±0.47 MPa units. The error (2σ) in measuring 100% Modulus is ±0.11 MPa units; the error (2σ) in measuring Elongation is ±13% units. Shore A hardness was measured at room temperature by using a Zwick Duromatic.

Oxygen permeability was measured using a MOCON OxTran Model 2/61 operating under the principle of dynamic measurement of oxygen transport through a thin film as published by Pasternak et al. in 8 JOURNAL OF POLYMER SCIENCE: PART A-2, P 467 (1970). The units of measure are cc-mm/m²-day-mmHg. Generally, the method is as follows: flat film or rubber samples are clamped into diffusion cells which are purged of residual oxygen using an oxygen free carrier gas. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units.

In certain embodiments, articles made from elastomeric composition described herein have desirable properties for air barriers such as innerliners. For example, the articles or elastomeric compositions suitable for those articles have brittleness values −45.0° C. or less, alternatively, −48.0° C. or less, alternatively, −49.0° C. or less, alternatively, −50.0° C. or less, alternatively, −51.0° C. or less, or, alternatively, −52.0° C. or less.

In another embodiment, the composition has a Shore A Hardness at 25° C. of less than 55.

In yet another embodiment, the composition has an air permeability at 65° C. of less than 3.50×10⁻⁸ cm³-cm/cm²-sec-atm.

In yet another embodiment, the composition has a MOCON at 60° C. of less than 37.5×10⁻⁸ cc-mm/m²-day-mmHg.

The composition can be used to make any number of articles. In one embodiment, the article is selected from tire curing bladders, tire innerliners, tire innertubes, and air sleeves. Other useful goods that can be made using compositions of the invention include hoses, seals, molded goods, cable housing, and other articles disclosed in THE VANDERBILT RUBBER HANDBOOK, P 637-772 (Ohm, ed., R.T. Vanderbilt Company, Inc. 1990).

Thus, the compositions of the present invention can be described alternately by any of the embodiments disclosed herein. For example, an aspect of the present invention may be described as a composition suitable for an air barrier comprising from 70 to 97 phr halogenated butyl rubber; from 3 to 25 phr polybutene processing oil; from 3 to 30 phr general purpose rubber; and from 3 to 25 phr of a plastomer, wherein the plastomer is a copolymer of ethylene derived units and C₃ to C₁₀ α-olefin derived units, the plastomer having a density of less than 0.915 g/cm³; and the composition having a Brittleness value of less than −45.0° C.

In another embodiment, the composition suitable for an air barrier consists essentially of an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³. In this embodiment, other minor components such as rosin oil, curatives and accelerators may also be present, individually, from 0.1 to 5 phr. And in yet another embodiment, the composition suitable for an air barrier consists essentially of an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³; and a polybutene processing oil. In this embodiment, other minor components such as rosin oil, curatives and accelerators may also be present, individually, from 0.1 to 5 phr.

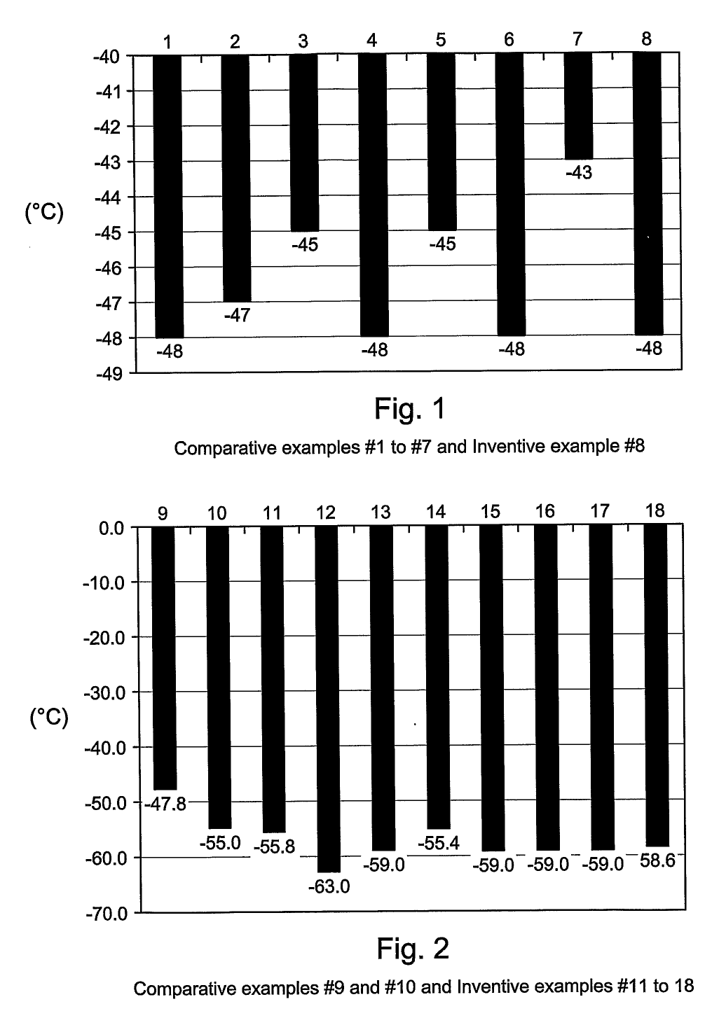

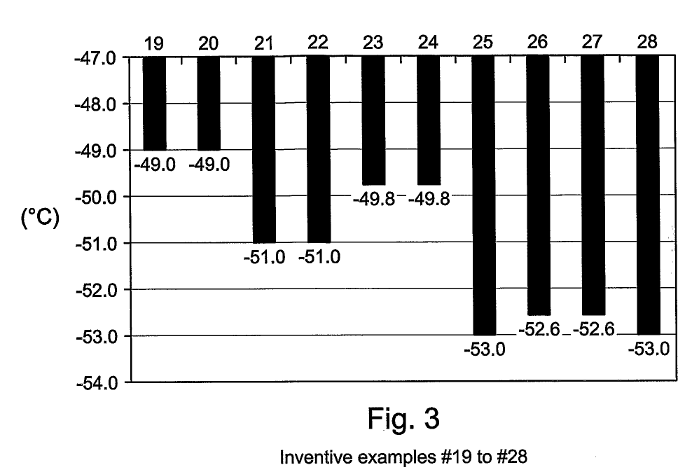

FIGS. 1, 2, and 3 show the brittleness temperatures (° C.) of Comparative examples #1 to #7 and Inventive examples #8 (FIG. 1); and Comparative examples #9 and #10 and Inventive examples #11 to #18 (FIG. 2); and Inventive examples #19 to #28 (FIG. 3).

TABLE 1
Test Methods

| Parameter | Units | Test |
|---|---|---|
| Mooney Viscosity (polymer) | ML 1 + 8, | ASTM D1646 |
| | 125° C., MU | |
| Mooney Viscosity (composition) | ML 1 + 4, | ASTM D1646 |
| | 100° C., MU | |
| Green Strength (100% Modulus) | PSI | ASTM D412 |
| MOCON (@ 60° C.) | cc-mm/m²-day- | See text |
| | mmHg | |
| Air Permeability (@ 65° C.) | (cm³-cm/cm²-sec- | See text |
| | atm) × 10⁸ | |
| Brittleness | ° C. | ASTM D746 |
| Mooney Scorch Time | ts5, 125° C., | ASTM D1646 |
| | minutes | |
| Oscillating Disk Rheometer (ODR) | | |
| @ 160° C., ±3°arc | | |
| Moving Die Rheometer (MDR) | | ASTM D2084 |
| @160° C., ±0.5°arc | | |
| ML | deciNewton · | |
| | meter | |
| MH | dNewton · m | |
| ts2 | minutes | |
| t50 | minutes | |
| t90 | minutes | |
| Physical Properties, press cured Tc | | |
| 90 + 2 min @ 160° C. | | |
| Hardness | Shore A | ASTM D2240 |
| Modulus 20%, 100%, 300% | MPa | ASTM D412 |
| | | die C |
| Tensile Strength | MPa | |
| Elongation at Break | % | |
| Energy to Break | N/mm (J) | |
| Hot Air Aging, 72 hrs. @ 125° C. | | ASTM D573 |
| Hardness | Shore A | |
| Modulus 20%, 100%, 300% | MPa | |
| Tensile Strength | MPa | |
| Elongation at Break | % | |
| Energy to Break | N/mm (J) | |
| DeMattia Flex | mm @ kilocycles | ASTM D813 |
| | | modified |

### EXAMPLES

The present invention, while not meant to be limiting by, may be better understood by reference to the following Examples and Tables. The ingredients used are outlined in Table 2, and the components of each example are outlined in Tables 3, 5, and 7 followed respectively by data for each example in Tables 4, 6 and 8.

TABLE 2
Various Components in the Compositions

| Component | Brief Description | Commercial Source |
|---|---|---|
| Bromobutyl-2222 | Brominated butyl rubber, | ExxonMobil Chemical |
| | 27-37 Mooney Viscosity | Company (Houston, TX) |
| Bromobutyl-2255 | Brominated butyl rubber, | ExxonMobil Chemical |
| | 41-51 Mooney Viscosity | Company (Houston, TX) |
| Bromobutyl-6222 | Brominated butyl rubber | ExxonMobil Chemical |
| | with styrene block | Company (Houston, TX) |
| | copolymer | |
| BUDENE ™ | cis-Polybutadiene | Goodyear Chemical |
| 1207 | | Company (Akron, OH) |
| BUNA CB 23 | cis-Polybutadiene | Lanxess (Leberkusen, |
| | | Germany) |
| CALSOL ™ 810 | Naphthenic Oil | R. E. Carroll, Inc |
| | ASTM Type 103 | (Trenton, NJ) |
| PARAPOL ™ | C₄ raffinate | ExxonMobil Chemical |
| | | Company (Houston, TX) |
| EXACT ™ 8201 | 0.822 g/cm³; 1.1 dg/min | ExxonMobil Chemical |
| | C₂/C₈ α-olefin copolymer | Company (Houston, TX) |
| Rosin Oil | Tackifier, including | Sovereign Chemical |
| MR-1085 A | unsaturated cyclic | (Akron, OH) |
| | carboxylic acids | |
| SP-1068 | Alkyl phenol formaldehyde | Schenectady Int. |
| | resin | (Schenectady, NY) |
| STRUKTOL ™ | Composition of aliphatic- | Struktol Co. of America |
| 40 MS | aromatic-naphthenic resins | (Stow, OH) |
| KADOX ™ 911 | High Purity French | Zinc Corp. of America |
| | Process Zinc Oxide | (Monaca, PA) |
| KADOX ™ 930 | High Purity French | Zinc Corp. of America |
| | Process Zinc Oxide | (Monaca, PA) |
| MBTS | 2-Mercaptobenzothiazole | R. T. Vanderbilt |
| | disulfide | (Norwalk, CT) or |
| | | Elastochem |
| | | (Chardon, OH) |
| MAGLITE-K ™ | Magnesium Oxide | C. P. Hall Co. |
| | | (Stow, OH) |

Mixing of compounds shown in Tables 3, 5, and 7 was performed in a BR Banbury™ internal mixer with tangential rotors. 100% of the elastomer or elastomers and the Struktol 40 MS resin were first mixed for 30 seconds or until the temperature reached about 60° C. Then, ¾ of the filler is added to the mixer, and mixing continues until the temperature reaches from 120 to 140° C. Next, the remaining filler, the processing oil, processing aids, and stearic acid are added, and mixing continues until the temperature reaches from 140 to 160° C. The finished masterbatch mixture is then finished by sheeting out on an open two-roll mill and allowed to cool at room temperature to about 40° C. The masterbatch mixture and all remaining curative ingredients (zinc oxide, accelerator(s), and sulfur) are combined together on an open two-roll mill at a temperature up to 100° C. as the finalized mixture is sheeted out.

TABLE 3
Rubber Compound Formulations

| Compound | 1 | 2 | 3 | 4 | 5 | 6 | 7 | 8 |
|---|---|---|---|---|---|---|---|---|
| Bromobutyl Rubber 2222 | 80.0 | 90.0 | 100.0 | 80.0 | 80.0 | 80.0 | 80.0 | 90.0 |
| Natural Rubber | 20.0 | 10.0 | | 20.0 | 20.0 | 20.0 | 20.0 | |
| BR, Budene 1207 | | | | | | | | 10.0 |
| Carbon Black, N660 | 60.0 | 60.0 | 60.0 | 60.0 | 60.0 | 60.0 | 60.0 | 60.0 |
| Stearic Acid | 1.0 | 1.0 | 1.0 | 1.0 | 1.0 | 1.0 | 1.0 | 1.0 |
| Processing Oil, Calsol 810 | 14.0 | 14.0 | 14.0 | 10.0 | 7.0 | 7.0 | | 14.0 |
| Processing Aid, Rosin Oil | 4.0 | 4.0 | 4.0 | | | | | 4.0 |
| MR-1085A | | | | | | | | |
| Resin, SP1068 | | | | 4.0 | 4.0 | 4.0 | 4.0 | |
| Resin, Struktol 40MS | | | | | 7.0 | | 7.0 | |
| Polybutene, Parapol 2500 | | | | | | 7.0 | 7.0 | |
| Zinc Oxide, Kadox-930 | 3.0 | 3.0 | 3.0 | 3.0 | 3.0 | 3.0 | 3.0 | 3.0 |
| Accelerator, MBTS | 1.25 | 1.25 | 1.25 | 1.25 | 1.25 | 1.25 | 1.25 | 1.25 |
| Sulfur | 0.1 | 0.1 | 0.1 | 0.1 | 0.1 | 0.1 | 0.1 | 0.1 |

TABLE 4
Rubber Compound Properties

| Properties | 1 | 2 | 3 | 4 | 5 | 6 | 7 | 8 |
|---|---|---|---|---|---|---|---|---|
| MOONEY Scorch, t5@135° C. | 19.21 | 12.91 | 9.26 | 7.7 | 14.67 | 9.97 | 12.71 | 9.13 |
| MOONEY Viscosity, | 45.3 | 45.7 | 44.1 | 50.5 | 49.2 | 48.9 | 54.3 | 49.3 |
| ML(1 + 4)@100° C. | | | | | | | | |
| Green Strength, 100% Modulus, | 42.63 | 39.44 | 36.83 | 51.04 | 45.97 | 48.00 | 54.67 | 42.78 |
| PSI | | | | | | | | |
| Time to Decay 75%, minutes | 1.77 | 1.86 | 2.58 | 6.15 | 4.57 | 7.40 | 9.15 | 3.75 |
| ODR@150° C., 1 deg Arc | | | | | | | | |
| ML | 4.67 | 4.67 | 4.41 | 5.48 | 4.89 | 5.57 | 5.71 | 5.49 |
| MH | 10.36 | 10.76 | 11.17 | 14.73 | 11.83 | 13.83 | 12.86 | 12.83 |
| ts2 | 8.00 | 5.47 | 3.85 | 6.34 | 7.86 | 6.68 | 7.55 | 3.91 |
| t25 | 7.20 | 5.05 | 3.66 | 6.78 | 7.25 | 6.77 | 7.09 | 3.82 |
| t50 | 8.97 | 6.21 | 4.50 | 9.59 | 10.37 | 9.36 | 10.25 | 4.69 |
| t90 | 13.29 | 9.29 | 6.81 | 16.01 | 18.37 | 15.26 | 18.11 | 8.44 |
| TENSILE PROPERTIES, Cured 20 min | | | | | | | | |
| @150° C. | | | | | | | | |
| Hardness, Shore A | 50.1 | 52.1 | 53.9 | 52.1 | 48.5 | 52.3 | 50.3 | 51.9 |
| 100% Modulus, MPa | 1.03 | 0.98 | 1.10 | 1.20 | 0.91 | 1.21 | 1.12 | 1.19 |
| 300% Modulus, MPa | 3.84 | 3.09 | 3.27 | 4.84 | 2.73 | 4.96 | 3.54 | 3.73 |
| Tensile, MPa | 8.33 | 7.84 | 7.59 | 9.01 | 8.09 | 9.06 | 8.61 | 8.24 |
| Energy to Break, N/mm | 9.31 | 10.17 | 9.49 | 7.31 | 9.88 | 7.99 | 10.09 | 11.40 |
| Elongation at Break, % | 691% | 820% | 739% | 555% | 802% | 564% | 763% | 787% |
| Air Permeability, (cm³-cm/cm²-sec- | 5.20 | 4.31 | 3.25 | 4.62 | 4.47 | 3.24 | 4.26 | 3.23 |
| atm) 10⁸ @ 65° C. | | | | | | | | |
| Brittleness, ° C. | −48 | −47 | −45 | −48 | −45 | −48 | −43 | −48 |

Table 3 shows formulations of Comparative examples #1 to #7, and Inventive example #8. Comparative examples #6 and #7 contain the polybutene processing aid, but do not contain the cis-polybutadiene general purpose elastomer. Inventive example #8 contains the cis-polybutadiene, but not the polybutene processing aid. Table 4 shows physical property data. Inventive example #8 has a lower brittleness point (−48° C.) than Comparative examples #2, #3, #5, and #7, and a reduced air permeability value than Comparative examples #1, #4, #5, and #6, displaying the lowest combination of both values while maintaining the other physical properties measured.

TABLE 5
Rubber Compound Formulations

| COMPOUND | 9 | 10 | 11 | 12 | 13 | 14 | 15 | 16 | 17 | 18 |
|---|---|---|---|---|---|---|---|---|---|---|
| Bromobutyl Rubber 2222 | 80.0 | 60.0 | 80.0 | 60.0 | 70.0 | 70.0 | 70.0 | 70.0 | 70.0 | 70.0 |
| Natural Rubber, SMR20 | 20.0 | 40.0 | | | 15.0 | 15.0 | 15.0 | 15.0 | 15.0 | 15.0 |
| BR, BUNA CB 23 | | | 20.0 | 40.0 | 15.0 | 15.0 | 15.0 | 15.0 | 15.0 | 15.0 |
| Carbon Black, N-330 | 30.0 | 30.0 | 30.0 | 30.0 | 30.0 | 30.0 | 30.0 | 30.0 | 30.0 | 30.0 |
| Processing Oil, Calsol 810 | 8.0 | 8.0 | 8.0 | 8.0 | 8.0 | 4.0 | | | | |
| Stearic Acid | 1.0 | 1.0 | 1.0 | 1.0 | 1.0 | 1.0 | 1.0 | 1.0 | 1.0 | 1.0 |
| Polybutene, Parapol 1300 | | | | | | | 8.0 | 4.0 | | |
| Plastomer, Exact 8201 | | | | | | | | | 8.0 | 4.0 |
| Zinc oxide, Kadox-911 | 1.0 | 1.0 | 1.0 | 1.0 | 1.0 | 1.0 | 1.0 | 1.0 | 1.0 | 1.0 |
| Accelerator, MBTS | 1.25 | 1.25 | 1.25 | 1.25 | 1.25 | 1.25 | 1.25 | 1.25 | 1.25 | 1.25 |
| Sulfur | 0.5 | 0.5 | 0.5 | 0.5 | 0.5 | 0.5 | 0.5 | 0.5 | 0.5 | 0.5 |

TABLE 6
Rubber Compound Properties

| Properties | 9 | 10 | 11 | 12 | 13 | 14 | 15 | 16 | 17 | 18 |
|---|---|---|---|---|---|---|---|---|---|---|
| MOONEY Scorch, t5@135 C. | 12.18 | 10.92 | 14.47 | 14.67 | 12.50 | 10.33 | 11.73 | 11.03 | 11.75 | 9.82 |
| MOONEY Viscosity, | 43.8 | 39.4 | 47.2 | 48.6 | 45.3 | 52.5 | 49.4 | 51.4 | 56.2 | 58.6 |
| ML(1 + 4)@100° C. | | | | | | | | | | |
| ODR@160° C., 3 deg Arc | | | | | | | | | | |
| ML | 9.32 | 8.62 | 10.66 | 12.29 | 10.36 | 12.18 | 11.75 | 11.94 | 12.55 | 13.57 |
| MH | 36.50 | 41.93 | 34.90 | 41.36 | 38.67 | 43.46 | 41.03 | 40.74 | 39.84 | 44.05 |
| ts2 | 3.63 | 3.16 | 3.16 | 3.27 | 3.56 | 3.21 | 3.54 | 3.28 | 3.39 | 3.25 |
| t25 | 5.58 | 5.03 | 4.54 | 4.83 | 5.47 | 5.14 | 5.53 | 5.09 | 5.09 | 5.08 |
| t50 | 7.56 | 6.62 | 6.14 | 6.13 | 7.27 | 6.75 | 7.42 | 6.74 | 6.51 | 6.53 |
| t90 | 12.04 | 11.78 | 10.90 | 12.75 | 12.83 | 11.80 | 12.64 | 11.72 | 10.76 | 10.99 |
| TENSILE PROPERTIES, Cured | | | | | | | | | | |
| t90 + 2 min @160° C. | | | | | | | | | | |
| Hardness, Shore A | 36.5 | 35.1 | 41.9 | 41.9 | 41.5 | 43.9 | 43.3 | 44.5 | 48.9 | 47.7 |
| 100% Modulus, MPa | 0.85 | 0.88 | 1.07 | 1.14 | 1.01 | 1.10 | 1.07 | 1.13 | 1.42 | 1.18 |
| 200% Modulus, MPa | 1.90 | 2.03 | 2.18 | 2.18 | 2.17 | 2.43 | 2.33 | 2.48 | 2.89 | 2.52 |
| 300% Modulus, MPa | 3.62 | 4.00 | 3.76 | 3.63 | 3.88 | 4.38 | 4.13 | 4.37 | 4.92 | 4.50 |
| Tensile, MPa | 12.93 | 16.39 | 11.63 | 12.65 | 12.52 | 14.42 | 12.49 | 11.35 | 12.03 | 13.61 |
| % ELONGATION | 659 | 664 | 667 | 691 | 653 | 662 | 628 | 589 | 589 | 649 |
| AGED TENSILE, 72 Hrs@125° C. | | | | | | | | | | |
| Hardness, Shore A | 47.1 | 43.3 | 59.7 | 54.5 | 51.3 | 52.9 | 52.9 | 49.3 | 55.1 | 57.1 |
| 100% Modulus, MPa | 1.46 | 1.34 | 2.87 | 1.76 | 2.16 | 2.07 | 2.13 | 1.82 | 2.40 | 2.58 |
| 200% Modulus, MPa | 3.38 | 3.07 | 5.93 | 3.64 | 4.76 | 4.75 | 4.48 | 4.20 | 5.18 | 5.50 |
| 300% Modulus, MPa | 6.07 | 5.41 | 7.46 | 6.08 | 6.75 | 7.31 | 6.95 | 6.86 | 7.93 | 6.59 |
| Tensile, MPa | 9.93 | 6.88 | 8.64 | 10.25 | 8.12 | 8.75 | 7.31 | 7.44 | 7.96 | 8.16 |
| Elongation, % | 458 | 370 | 296 | 456 | 334 | 336 | 320 | 332 | 304 | 297 |
| MOCON O2 Transmission @ 60° C. | 26.71 | 40.35 | 28.82 | 49.32 | 34.70 | 31.38 | 30.21 | 28.65 | 31.97 | 30.21 |
| Air Permeability, (cm³-cm/cm²-sec- | 4.70 | 8.31 | 5.57 | 9.70 | 6.72 | 5.86 | 6.31 | 5.68 | 6.86 | 5.64 |
| atm) 10⁸ @ 65° C. | | | | | | | | | | |
| Brittleness, ° C. | −47.8 | −55.0 | −55.8 | −63.0 | −59.0 | −55.4 | −59.0 | −59.0 | −59.0 | −58.6 |

Table 5 shows formulations of Comparative examples #9 and #10, and Inventive examples #11 to #18. Inventive examples #11 to #14 contain the cis-polybutadiene general purpose elastomer, but not the polybutene or plastomer processing aids. Inventive examples #15 and #16 contain the cis-polybutadiene and the polybutene processing aid. Inventive examples #17 and #18 contain the cis-polybutadiene and the plastomer processing aid. Table 6 shows physical property data. Inventive examples #11 to #18 have a lower brittleness point (<−55° C.) than Comparative examples #1 to #7 (Table 4), and #9 and #10. Inventive examples #11 and #14 to #18 have MOCON or air permeability values less than 20% higher than Comparative example #9. Inventive examples #11 and #13 to #18 have MOCON or air permeability values less than Comparative example #10.

TABLE 7
Rubber Compound Formulations

| Compounds | 19 | 20 | 21 | 22 | 23 | 24 | 25 | 26 | 27 | 28 |
|---|---|---|---|---|---|---|---|---|---|---|
| Bromobutyl Rubber 2222 | 80 | 80 | 70 | 70 | 75 | 70 | 70 | 70 | 70 | 70 |
| NR, SMR 20 | 10 | 5 | 20 | 10 | 10 | 15 | 15 | 15 | 15 | 15 |
| BR, Buna CB 23 | 10 | 15 | 10 | 20 | 15 | 15 | 15 | 15 | 15 | 15 |
| Carbon Black, N660 | 50 | 50 | 50 | 50 | 50 | 50 | 50 | 50 | 50 | 50 |
| Processing Oil, Calsol 810 | 8 | 8 | 8 | 8 | 8 | | | | | |
| Stearic Acid | 1 | 1 | 1 | 1 | 1 | 1 | 1 | 1 | 1 | 1 |
| Polybutene, Parapol 1300 | | | | | | 8 | 4 | | | |
| Plastomer, Exact 8201 | | | | | | | | 8 | 4 | |
| Process Aid, HVI PAO 23000 | | | | | | | | | | 8 |
| Zinc Oxide, Kadox 911 | 1 | 1 | 1 | 1 | 1 | 1 | 1 | 1 | 1 | 1 |
| Accelerator, MBTS | 1.25 | 1.25 | 1.25 | 1.25 | 1.25 | 1.25 | 1.25 | 1.25 | 1.25 | 1.25 |
| Sulfur | 0.5 | 0.5 | 0.5 | 0.5 | 0.5 | 0.5 | 0.5 | 0.5 | 0.5 | 0.5 |

TABLE 8
Rubber Compound Properties

| Properties | 19 | 20 | 21 | 22 | 23 | 24 | 25 | 26 | 27 | 28 |
|---|---|---|---|---|---|---|---|---|---|---|
| Mooney Scorch @135 C., t5, min | 11.22 | 11.58 | 9.12 | 9.68 | 11.13 | 8.93 | 7.98 | 7.18 | 7.87 | 8.16 |
| Mooney Scorch @135 C., t10, min | 16.97 | 16.32 | 11.7 | 14 | 16.47 | 11.6 | 10.18 | 9.13 | 10.75 | 10.61 |
| Mooney Viscosity, ML(1 + 4)@100 C. | 56 | 56.6 | 54 | 54 | 55.3 | 57.2 | 62.8 | 69.2 | 66.3 | 56.2 |
| ODR @160 C., 3 deg arc | | | | | | | | | | |
| ML, dN.m | 4.12 | 11.96 | 11.48 | 12.09 | 11.98 | 12.77 | 14.01 | 15.83 | 15.06 | 12.39 |
| MH, dN.m | 67.06 | 42.54 | 46.91 | 44.76 | 44.27 | 47.32 | 49.36 | 51.36 | 51 | 48.88 |
| ts2, min | 2.27 | 2.77 | 3.02 | 3.05 | 2.88 | 2.97 | 2.65 | 2.69 | 2.96 | 2.55 |
| t25, min | 3.55 | 4.87 | 5.58 | 5.4 | 5.22 | 5.72 | 5.14 | 5.24 | 5.39 | 5.2 |
| t50, min | 4.77 | 6.54 | 7.44 | 7.08 | 6.96 | 7.82 | 6.86 | 6.85 | 6.96 | 7.14 |
| t90, min | 12.83 | 10.77 | 13.31 | 12.76 | 11.94 | 13.95 | 11.98 | 11.51 | 11.42 | 13.58 |
| TENSILE PROPERTIES | | | | | | | | | | |
| Hardness, Shore A | 47.5 | 49.9 | 49.3 | 49.3 | 50.7 | 51.1 | 53.3 | 57.7 | 53.9 | 50.9 |
| 20% Modulus, MPa | 0.57 | 0.66 | 0.56 | 0.67 | 0.59 | 0.58 | 0.68 | 0.80 | 0.71 | 0.61 |
| 100% Modulus, MPa | 1.37 | 1.70 | 1.61 | 1.96 | 1.62 | 1.72 | 1.93 | 2.34 | 2.26 | 1.70 |
| 200% Modulus, MPa | 3.24 | 3.97 | 3.84 | 4.21 | 3.94 | 4.06 | 4.38 | 5.14 | 5.34 | 3.91 |
| 300% Modulus, MPa | 5.84 | 6.66 | 6.75 | 6.91 | 6.69 | 7.06 | 7.36 | 8.42 | 8.88 | 6.67 |
| Energy to Break, J | 8.80 | 8.45 | 9.52 | 8.50 | 8.82 | 9.31 | 7.76 | 9.79 | 8.44 | 9.07 |
| Tensile, MPa | 12.12 | 11.85 | 13.45 | 11.95 | 12.33 | 12.95 | 11.84 | 13.48 | 12.63 | 12.62 |
| Elongation to Break, % | 517.1 | 506.9 | 523.9 | 466.7 | 506.1 | 499.5 | 453.5 | 456.5 | 420.1 | 516.2 |
| AGED TENSILE PROPERTIES | | | | | | | | | | |
| Aged 20% Modulus, MPa | 0.91 | 1.14 | 0.81 | 0.90 | 1.05 | 0.80 | 0.88 | 0.90 | 0.80 | 0.87 |
| Aged 100% Modulus, MPa | 2.67 | 3.52 | 2.66 | 3.40 | 3.47 | 2.57 | 2.90 | 3.22 | 2.96 | 2.87 |
| Aged 200% Modulus, MPa | 5.46 | 6.73 | 5.69 | 7.42 | 6.93 | 5.29 | 5.80 | 7.13 | 6.76 | 5.71 |
| Aged 300% Modulus, MPa | 8.41 | 9.43 | 8.66 | 3.86 | 9.66 | 7.95 | 8.43 | 4.87 | 0.00 | 2.82 |
| Aged Energy to Break, J | 5.74 | 4.99 | 4.91 | 4.51 | 4.37 | 4.24 | 4.68 | 4.81 | 4.35 | 3.47 |
| Aged Tensile, MPa | 10.00 | 10.18 | 9.19 | 9.99 | 9.67 | 8.30 | 8.97 | 10.09 | 9.76 | 7.75 |
| Aged Elongation to Break, % | 368.0 | 317.3 | 339.9 | 287.7 | 300.5 | 313.5 | 327.4 | 293.1 | 281.3 | 274.9 |
| MOCON O2 Transmission @ 60° C. | 25.54 | 26.12 | 30.02 | 31.97 | 30.60 | 27.49 | 26.12 | 26.90 | 26.90 | 29.04 |
| Air Permeability, (cm³-cm/cm²- | 5.40 | 5.36 | 7.10 | 8.06 | 7.36 | 5.56 | 5.90 | 5.44 | 5.34 | 5.81 |
| sec-atm) 10⁸ @ 65° C. | | | | | | | | | | |
| Brittleness, ° C. | −49.0 | −49.0 | −51.0 | −51.0 | −49.8 | −49.8 | −53.0 | −52.6 | −52.6 | −53.0 |

Table 7 shows formulations of Inventive examples #19 to #28. Inventive examples #19 to #23 contain the cis-polybutadiene, but not the polybutene or plastomer or polyalphaolefin processing aid. Inventive examples #24 and #25 contain the cis-polybutadiene and the polybutene processing aid. Inventive examples #26 and #27 contain the cis-polybutadiene and the plastomer processing aid. Inventive example #28 contains the cis-polybutadiene and the polyalphaolefin processing aid. Table 8 shows physical property data. Inventive examples #19 to #28 have a lower brittleness point (<−49° C.) than Comparative examples #1 to #7 (Table 4) and #9 (Table 6). Inventive examples #19 and #20 containing the cis-polybutadiene, and Inventive examples #25 containing the cis-polybutadiene and the polybutene have lower MOCON values than Comparative example #9. Inventive examples #24 containing the cis-polybutadiene and the polybutene, and #26 and #27 containing the cis-polybutadiene and the plastomer have comparable MOCON permeability values to Comparative example #9.

We claim:

1-76. (canceled)

77. An article made from at least one cured elastomeric composition comprising from about 70 phr to about 97 phr of at least one halogenated isobutylene based elastomer and
from about 30 phr to about 3 phr of at least one secondary elastomer;
wherein the secondary elastomer has a Tg of about −65° C. or less and wherein the article has a brittleness point of about −48° C. or less.

78. The article of claim 77, wherein the secondary elastomer comprises units derived from butadiene, units derived from isoprene, or units derived from butadiene and isoprene.

79. The article of claim 78, wherein the secondary elastomer comprises butadiene rubber (BR), isoprene rubber (IR), or mixtures thereof.

80. The article of claim 79, wherein the butadiene rubber (BR) is selected from the group consisting of cis-polybutadiene, high cis-polybutadiene, or mixtures thereof.

81. The article of claim 80, wherein the butadiene rubber (BR) is 1,4-cis polybutadiene.

82. The article of claim 77, wherein the secondary elastomer has a Mooney viscosity of from about 30 to about 70 (as measured at 100° C. ML 1+4).

83. The article of claim 77, wherein the at least one halogenated isobutylene based elastomer comprises at least one halogenated butyl rubber.

84. The article of claim 83, wherein the at least one halogenated butyl rubber comprises from about 0.6 to about 2.4 mol % of isoprene present in the elastomer.

85. The article of claim 77, wherein the at least one halogenated isobutylene based elastomer comprises at least one halogenated “star-branched” butyl polymer.

86. The article of claim 85, wherein the at least one halogenated “star-branched” butyl polymer comprises from about 10 to about 20 weight % of high molecular weight branched molecules.

87. The article of claim 77, wherein the at least one halogenated isobutylene based elastomer comprises at least one halogenated random copolymer of isobutylene and methylstyrene, preferably para-methylstyrene.

88. The article of claim 87, wherein the at least one halogenated random copolymer of isobutylene and methylstyrene comprises at least 4.0 wt % methylstyrene, preferably para-methylstyrene, based upon the weight of the at least one halogenated random copolymer.

89. The article of claim 77, wherein the at least one cured elastomeric composition comprises from about 75 phr to about 97 phr of the at least one halogenated isobutylene based elastomer and from about 25 phr to about 3 phr of the at least one secondary elastomer.

90. The article of claim 77, wherein the at least one cured elastomeric composition further comprises natural rubber (NR), isoprene rubber (IR), styrene-co-butadiene rubber (SBR), isoprene-co-butadiene rubber (IBR), styrene-isoprene-butadiene rubber (SIBR), ethylene-propylene rubber (EP), ethylene-propylene-diene rubber (EPDM), or mixtures thereof.

91. The article of any of the preceding claims, wherein the at least one cured elastomeric composition further comprises at least one thermoplastic resin.

92. The article of claim 77, wherein the at least one cured elastomeric composition optionally comprises one or more of:
a) at least one filler selected from calcium carbonate, clay, mica, silica, silicates, talc, titanium dioxide, starch, wood flour, carbon black, or mixtures thereof;
b) at least one clay selected from montmorillonite, nontronite, beidellite, volkonskoite, laponite, hectorite, saponite, sauconite, magadite, kenyaite, stevensite, vermiculite, halloysite, aluminate oxides, hydrotalcite, or mixtures thereof, optionally, treated with modifying agents;
c) at least one processing oil selected from aromatic oil, naphthenic oil, paraffinic oil, or mixtures thereof;
d) at least one processing aid selected from polybutene, plastomer, polyalphaolefin oils, or mixtures thereof;
e) any combination of a-d.

93. The article of claim 77, wherein the article has a MOCON (as herein defined) of 37.5 mm/m²-day-mmHg or less.

94. The article of claim 77, wherein the article is selected from the group consisting of innerliners, bladders, air membranes, innertubes, air barriers, films, layers (microlayers and/or multilayers), treads, and sidewalls.

95. A tire comprising the article of claim 77.

96. The tire of claim 95, wherein the tire is an aircraft tire.

97. A process to improve the brittleness point of an article, the process comprising producing the article from at least one cured elastomeric composition; wherein the at least one cured elastomeric composition comprises an effective amount of at least one halogenated isobutylene based elastomer and at least one secondary elastomer to impart a brittleness point of about −48° C. or less to the article; wherein the at least one secondary elastomer has a Tg of about −65° C.

98. The process of claim 97, wherein the secondary elastomer comprises units derived from butadiene, units derived from isoprene, or units derived from butadiene and isoprene.

99. The process of claim 97, wherein the secondary elastomer has a Mooney viscosity of from about 30 to about 70 (as measured at 100° C. ML 1+4).

100. The process of claim 97, wherein the at least one halogenated isobutylene based elastomer comprises at least one halogenated butyl rubber.

101. The process of claim 97, wherein the at least one halogenated isobutylene based elastomer comprises at least one halogenated “star-branched” butyl polymer.

102. The process of claim 97, wherein the at least one halogenated isobutylene based elastomer comprises at least one halogenated random copolymer of isobutylene and methylstyrene, preferably para-methylstyrene.

103. The process of claim 97, wherein the at least one cured elastomeric composition comprises from about 70 phr to about 97 phr of the at least one halogenated isobutylene based elastomer and from about 30 phr to about 3 phr of the at least one secondary elastomer.

104. The process of claim 97, wherein the at least one cured elastomeric composition optionally comprises one or more of:
a) at least one filler selected from calcium carbonate, clay, mica, silica, silicates, talc, titanium dioxide, starch, wood flour, carbon black, or mixtures thereof;
b) at least one clay selected from montmorillonite, nontronite, beidellite, volkonskoite, laponite, hectorite, saponite, sauconite, magadite, kenyaite, stevensite, vermiculite, halloysite, aluminate oxides, hydrotalcite, or mixtures thereof, optionally, treated with modifying agents;
c) at least one processing oil selected from aromatic oil, naphthenic oil, paraffinic oil, or mixtures thereof;
d) at least one processing aid selected from polybutene, plastomer, polyalphaolefin oils, or mixtures thereof;
e) any combination of a-d.

105. The process of claim 97, wherein the article has a MOCON (as herein defined) of 37.5 mm/m²-day-mmHg or less.

106. The process of claim 97, wherein the article is selected from the group consisting of innerliners, bladders, air membranes, innertubes, air barriers, films, layers (microlayers and/or multilayers), treads, and sidewalls.
